(19) United States
(12) Patent Application Publication
(10) Pub. No.: US 2019/0049000 A1
(43) Pub. Date: Feb. 14, 2019

(54) SYSTEM TO CONTROL A MANUAL TRANSMISSION

(71) Applicant: Continental Automotive Systems, Inc., Auburn Hills, MI (US)

(72) Inventor: David Poot Rodriguez, Tlaquepaque (MX)

(73) Assignee: Continental Automotive Systems, Inc., Auburn Hills, MI (US)

(21) Appl. No.: 15/672,602

(22) Filed: Aug. 9, 2017

(51) Int. Cl. F16H 61/04; B62D 15/02; B60W 30/165

(52) U.S. Cl. CPC F16H 61/0403; F16H 2061/0418; B60W 30/165; B62D 15/0285

(57) ABSTRACT

An automated single clutch transmission, which includes an intelligent gear shift lever, an engager, an electronic clutch actuator, and at least one control unit in electrical communication with the intelligent gear shift lever, the engager, and the electronic clutch actuator. A clutch mechanism is in electrical communication with the electronic clutch actuator. The intelligent gear shift lever configures the automated single clutch transmission for operating in one of a plurality of gear configurations, and the engager is used to command the electronic clutch actuator to change the clutch mechanism between an engaged configuration and a disengaged configuration. The engager may be a rotatable shift knob connected to the intelligent gear shift lever, a secondary movement of the intelligent shift lever, or an electronic clutch pedal.

### FIELD OF THE INVENTION

The invention relates generally to a system for performing gear shifts in a manual transmission using an intelligent gear shift lever and an electronically actuated clutch mechanism.

### BACKGROUND OF THE INVENTION

A transmission includes various gears having different gear ratios, and the transmission is placed in different configurations to transfer power from a power source, such as an engine, to an output shaft of the transmission. The power input to the transmission is related to angular velocity and torque from the engine, where the torque may be reduced or amplified by the transmission, depending upon the selected gear ratio. There are several types of transmissions used in vehicles, such as a manual transmission, an automatic transmission, and a dual-clutch transmission.

The selection of any of the multiple gear ratios in a manual transmission is made with a gear shift lever that moves a synchronizer in position to synchronize the input shaft with the desired gear ratio (and the output shaft). The power source is not typically directly connected to the transmission input shaft, the connection is made through a clutch used to selectively engage and disengage the output shaft of the engine with the transmission input shaft.

The gear ratio selection in a manual transmission requires the power source to be disengaged from the transmission, such that the synchronizer may move freely between selected gears. After the synchronizer is used to select a new gear ratio, the engine is engaged again to the transmission input using the clutch, and the engine resumes transferring power to the transmission.

A manual transmission requires a driver to successfully synchronize the operation of various components, such as the clutch, the power received from the engine (via force applied to the accelerator pedal), and the gear selection of the transmission. During the operation of a manual transmission, human errors are typically as result of synchronizer (gear) selection, improper clutch operation, and power loss between gear shifts.

The gear ratio in an automatic transmission is selected automatically using solenoid valves, a hydraulic system, and several hydraulically actuated clutches. An automatic transmission includes a torque converter for transferring power from the engine to the transmission, instead of a manually operated dry clutch. The operation of an automatic transmission also includes an electronic controller used for controlling when and how a gear shift is performed. Some automatic transmissions include a “manual” gear selection, where the driver may select a desired gear. Automatic transmissions have several drawbacks, including increased production costs due to the inclusion of a hydraulic system, torque converter, hydraulic clutches, and the electronic controller. Automatic transmissions are also typically less efficient than manual transmissions.

Another type of transmission is a dual-clutch transmission. These types of transmissions typically include two electronically actuated clutches used to shift between gears. An electronic controller controls the two electronically actuated clutches, and changes the configurations of the clutches to perform the various gear shifts. Some dual-clutch transmissions offer a “manual” gear selection, where the driver controls when the gear shifts occur. This is typically achieved through the use of some type of actuator, such as multiple buttons or levers mounted on the steering wheel. Dual-clutch transmissions are expensive to manufacture, due to the cost of two electronically actuated clutches, and the actuator for each clutch, the actuator for each synchronizer, and the controller.

Accordingly, there exists a need for a less expensive transmission, which is able to perform gear shifts using a single clutch, and overcomes the aforementioned drawbacks.

### SUMMARY OF THE INVENTION

The present invention is an Automated Single Clutch Transmission (ASCT), which includes a transmission having several configurations for achieving different gear ratios between an input shaft and an output shaft, where the ASCT also includes an intelligent gear shift lever (IGSL), an engager, a controller, such as a transmission control unit (TCU), an electronic clutch actuator (ECA), and a clutch mechanism.

The ASCT also includes synchronizers and forks, and the gear shifting of the ASCT is controlled manually using the IGSL, the synchronizers and the forks. They are mechanically (manually) displaced by the IGSL to configure the transmission to operate in a desired gear.

The intelligent gear shift lever is able to be placed in a number of configurations which correspond to the number of gear ratios in the transmission, including reverse. One of the features of the present invention is an engager, which in one embodiment is part of the intelligent gear shift lever. The engager is used to send an activation signal to the TCU to actuate the ECA, selectively engaging and disengaging the clutch mechanism. The gear engagement is achieved separately from the actuation of the clutch mechanism, thus, the synchronizer may be engaged to the one of the gears in the transmission, but the clutch mechanism is not actuated unless the engager is used to send a signal is sent to the ECA to change the clutch mechanism to an engaged configuration.

The controller identifies whether a gear is synchronized and the status of the engager after the position of the intelligent gear shift lever is recognized. The controller uses as many inputs as needed, such as, but not limited to: accelerometers, vehicle speed, engine speed, transmission input shaft speed, the configuration of the clutch mechanism, transmission temperature, engine temperature, accelerator pedal position, brake pedal position, etc. to determine the clutch activation speed (engagement speed) in order to successfully transfer the torque produced from the engine to the transmission.

In one embodiment, the transmission of the present invention includes automatic activation of the engager upon synchronizer engagement detection by the TCU, such that the clutch mechanism is engaged without driver input.

In another embodiment, the engager may be an electronic clutch pedal (ECP). The electronic clutch pedal is part of a configuration of the ASCT, where the position of the electronic clutch pedal is detected by the TCU, and depending upon the position of the ECP, the TCU commands the ECA to change the clutch mechanism to an engaged or disengaged configuration.

The ASCT of the present invention has several benefits, one of which is that the driver has full control of the transmission gear shifting, and the ASCT may be used to provide engine braking. Damage to the clutch mechanism due to human operational error is prevented due to the clutch mechanism being controlled by the ECA. The ASCT of the present invention is a low-complexity and low cost design, there is no need for the inclusion of hydraulic systems used in automated/automatic transmissions. The IGSL, engager, and ECA may be adapted for use in existing manual transmissions, offering automobile manufacturers the possibility of selling a potentially low-cost, semi-automated transmission.

In one embodiment, the present invention is an automated single clutch transmission, which includes an intelligent gear shift lever, an engager, a clutch mechanism, and at least one control unit in electrical communication with the intelligent gear shift lever, the engager, and the clutch mechanism such that the control unit is able to receive signals from the intelligent gear shift lever and the engager, and the control unit controls the actuation of the clutch mechanism based on the signals received from the intelligent gear shift lever and the engager. The intelligent gear shift lever is used to configure the automated single clutch transmission for operating in one of a plurality of gear configurations, and the engager is used to command the control unit to change the clutch mechanism between an engaged configuration and a disengaged configuration.

In one embodiment, the engager is a rotatable shift knob connected to the intelligent gear shift lever, and the shift knob is rotated in a first direction to send a signal to the control unit such that the control unit places the clutch mechanism in the engaged configuration. The shift knob is rotated in a second direction to send a signal to the control unit such that the control unit places the clutch mechanism in a disengaged configuration.

In another embodiment, the engager is a secondary movement of the intelligent shift lever, such that after the intelligent gear shift lever is used to configure the automated single clutch transmission for operating in one of a plurality of gear configurations, the secondary movement of the intelligent gear shift lever along an angle in a first direction sends a signal to the control unit to place the clutch mechanism in the engaged configuration, and the secondary movement of the intelligent gear shift lever along the angle in a second direction sends a signal to the control unit to place the clutch mechanism in the disengaged configuration.

In another embodiment, the engager may be one or more sensors operable for detecting when it is desired to change the transmission for operating in one of the plurality of gear configurations

In another embodiment, the engager is an electronic clutch pedal, where upon application of force to the electronic clutch pedal, a signal is sent to the control unit that the electronic clutch pedal has been actuated, and the control unit changes the clutch mechanism to the disengaged configuration. When force is no longer applied to the electronic clutch pedal, a signal is sent to the control unit that the electronic clutch pedal has been released, and the control unit changes the clutch mechanism to the engaged configuration.

The automated single clutch transmission of the present invention also includes a park-assist mode of operation. A rear proximity sensor is in electrical communication with the control unit. In the park-assist mode of operation, after the intelligent gear shift lever is used to configure the transmission to a reverse mode of operation and the engager is used to change the clutch mechanism to the engaged configuration, as the vehicle is moving backward the controller changes the clutch mechanism to the disengaged configuration when the rear proximity sensor detects an object behind the vehicle.

The vehicle includes a brake system, and in one embodiment, the controller is in electrical communication with the brake system such that during the park-assist mode of operation, when the rear proximity sensor detects an object behind the vehicle, the controller commands the brake system to decrease the speed of the vehicle as the at least one controller disengages the clutch mechanism.

The automated single clutch transmission of the present invention also includes a follow-car mode of operation. A front proximity sensor is in electrical communication with the control unit. The control unit commands the electronic clutch actuator to change the clutch mechanism between the engaged configuration and the disengaged configuration to selectively transfer power to the transmission such that the vehicle moves at the same pace as the followed vehicle. When the follow car mode of operation is used, the controller is in electrical communication with the brake system such that the at least one controller commands the brake system to decrease the speed of the vehicle and the at least one controller disengages the clutch mechanism if the followed vehicle decreases speed.

In an embodiment, the automated single clutch transmission of the present invention also includes an electronic clutch actuator in electrical communication with the control unit for controlling the clutch mechanism. The control unit is able to receive signals from the intelligent gear shift lever and the engager, and the control unit is able to send signals to the electronic clutch actuator based on the signals received from the intelligent gear shift lever and the engager to change the clutch mechanism between the engaged configuration and the disengaged configuration.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of a powertrain system of a vehicle having an automated single clutch transmission, according to embodiments of the present invention; and

FIG. 2 is a perspective view of an intelligent gear shift lever used as part of an automated single clutch transmission, according to embodiments of the present invention;

FIG. 3A is a diagram of a shift pattern for an intelligent gear shift lever, indicating that the shift lever is configured such that the transmission is in a neutral configuration, according to embodiments of the present invention;

FIG. 3B is a top view of a shift lever used as part of an automated single clutch transmission, the shift lever having a shift pattern representing the positions the shift lever is configured to in order for the automated single clutch transmission to operate in a desired gear, with an icon representing that the shift lever is in the neutral configuration, according to embodiments of the present invention;

FIG. 4A is a diagram of a shift pattern for an intelligent gear shift lever, indicating that the shift lever is configured such that the transmission is in a first gear configuration, according to embodiments of the present invention;

FIG. 4B is a top view of a shift lever used as part of an automated single clutch transmission, the shift lever having a shift pattern representing the positions the shift lever is configured to in order for the automated single clutch transmission to operate in a desired gear, with an icon representing that the shift lever is in the first gear configuration, according to embodiments of the present invention;

FIG. 5A is a diagram of a shift pattern for an intelligent gear shift lever, indicating that the shift knob of the shift lever is rotated to place a clutch mechanism in an engaged configuration, according to embodiments of the present invention;

FIG. 5B is a top view of a shift lever used as part of an automated single clutch transmission, the shift lever having a shift pattern representing the positions the shift lever is configured to in order for the automated single clutch transmission to operate in a desired gear, with an icon representing that the shift lever is in the first gear configuration, and an indication that the shift knob of the shift lever is being rotated to place a clutch mechanism in an engaged configuration, according to embodiments of the present invention;

FIG. 6A is a diagram of a shift pattern for an intelligent gear shift lever, indicating that the shift knob of the shift lever is rotated to place a clutch mechanism in a disengaged configuration, according to embodiments of the present invention;

FIG. 6B is a top view of a shift lever used as part of an automated single clutch transmission, the shift lever having a shift pattern representing the positions the shift lever is configured to in order for the automated single clutch transmission to operate in a desired gear, with an icon representing that the shift lever is in the first gear configuration, and an indication that the shift knob of the shift lever is being rotated to place a clutch mechanism in a disengaged configuration, according to embodiments of the present invention;

FIG. 7A is a diagram of a shift pattern for an intelligent gear shift lever, indicating that the shift lever is configured such that the transmission is in a second gear configuration, according to embodiments of the present invention;

FIG. 7B is a top view of a shift lever used as part of an automated single clutch transmission, the shift lever having a shift pattern representing the positions the shift lever is configured to in order for the automated single clutch transmission to operate in a desired gear, with an icon representing that the shift lever is in the second gear configuration, according to embodiments of the present invention;

FIG. 8A is a diagram of a shift pattern for an intelligent gear shift lever, indicating that the shift knob of the shift lever is rotated to place a clutch mechanism in an engaged configuration, according to embodiments of the present invention;

FIG. 8B is a top view of a shift lever used as part of an automated single clutch transmission, the shift lever having a shift pattern representing the positions the shift lever is configured to in order for the automated single clutch transmission to operate in a desired gear, with an icon representing that the shift lever is in the second gear configuration, and an indication that the shift knob of the shift lever is being rotated to place a clutch mechanism in an engaged configuration, according to embodiments of the present invention;

FIG. 9 is a diagram of a vehicle incorporating an automated single clutch transmission, according to embodiments of the present invention;

FIG. 10A is a top view of an alternate embodiment of a shift lever used as part of an automated single clutch transmission, the shift lever having a shift pattern representing the positions the shift lever is configured to in order for the automated single clutch transmission to operate in a desired gear, with an icon representing that the shift lever is in the neutral configuration, according to embodiments of the present invention;

FIG. 10B is a top view of an alternate embodiment of a shift lever used as part of an automated single clutch transmission, the shift lever having a shift pattern representing the positions the shift lever is configured to in order for the automated single clutch transmission to operate in a desired gear, with an icon representing that the shift lever is in the first gear configuration, according to embodiments of the present invention;

FIG. 10C is a side view of an alternate embodiment of a shift lever in various configurations, where the shift lever is used as part of an automated single clutch transmission to configure the automated single clutch transmission to operate in first gear;

FIG. 10D is a top view of an alternate embodiment of a shift lever used as part of an automated single clutch transmission, the shift lever having a shift pattern representing the positions the shift lever is configured to in order for the automated single clutch transmission to operate in a desired gear, with an icon representing that the shift lever is in the second gear configuration, according to embodiments of the present invention; and

FIG. 10E is a side view of an alternate embodiment of a shift lever in various configurations, where the shift lever is used as part of an automated single clutch transmission to configure the automated single clutch transmission to operate in second gear.

### DETAILED DESCRIPTION OF THE PREFERRED EMBODIMENTS

The following description of the preferred embodiment(s) is merely exemplary in nature and is in no way intended to limit the invention, its application, or uses.

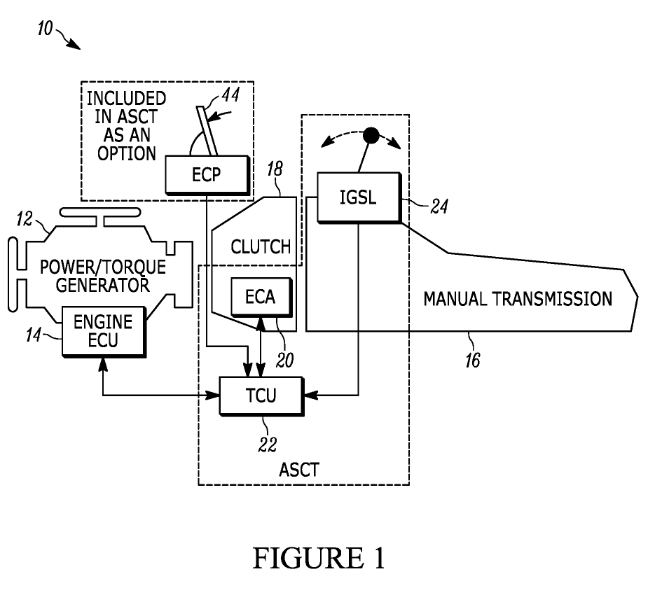

A diagram of a powertrain system for a vehicle incorporating an automated single clutch transmission (ASCT) with intelligent gear shift is shown in FIG. 1 generally at 10. The powertrain system 10 includes an engine 12 in electrical communication with an engine control unit (ECU) 14. The system 10 further includes a transmission 16 which is selectively engaged with the engine 12 through the use of a clutch mechanism 18 having an electronic clutch actuator (ECA) 20. The transmission 16 in this embodiment is a single clutch transmission having multiple configurations used to transmit power from the engine 12 at various gear ratios. The clutch mechanism 18 has two configurations, a first, or disengaged configuration, and a second, or engaged configuration. The ECA 20 and the ECU 14 are both in electrical communication with a transmission control unit (TCU) 22, and the TCU 22 is also in electrical communication with an intelligent gear shift lever (IGSL) 24.

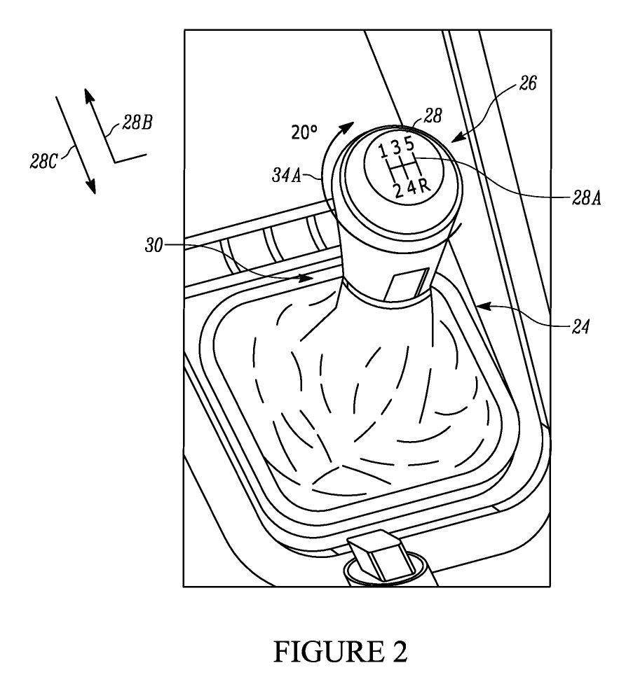

Referring now to FIG. 2, the IGSL 24 also includes an engager, shown generally at 26, which in this embodiment is a rotatable shift knob 28 mounted to a shift lever, shown generally at 30. The shift knob 28 includes the pattern, shown generally at 28A, which represents the positions the lever 30 is configured to in order to configure the transmission 16 to operate in the desired gear.

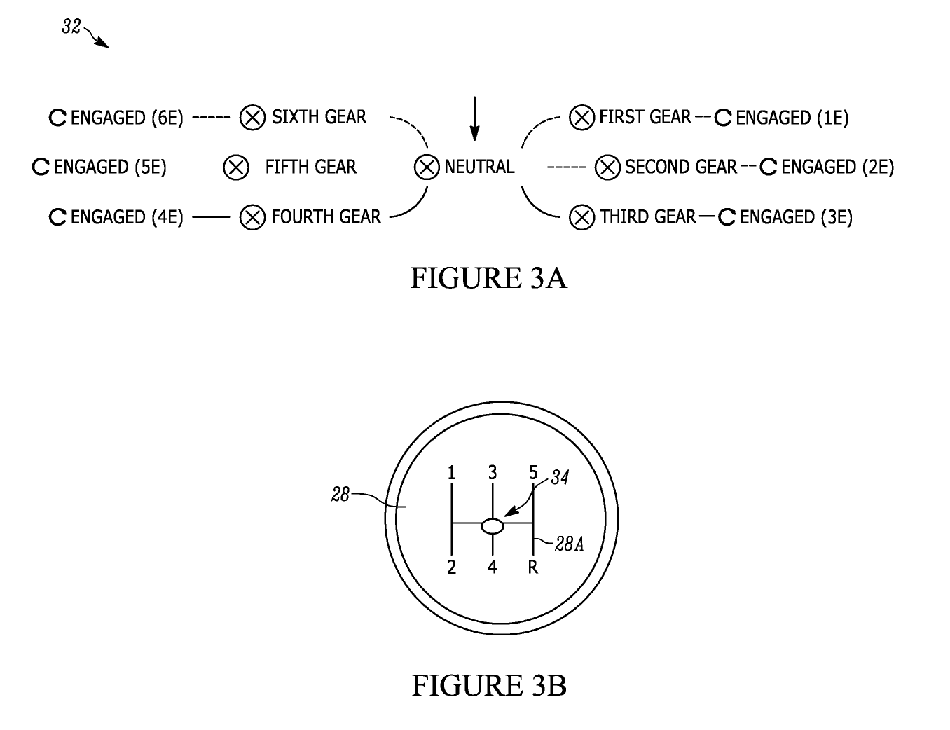

Referring now to FIGS. 3A and 3B, a diagram is shown generally at 32 which depicts the various configurations the shift lever 30 is placed into in order to change the working gear in the transmission 16. The transmission 16 is in neutral, and the shift lever 30 is in the position as indicated by an icon 34.

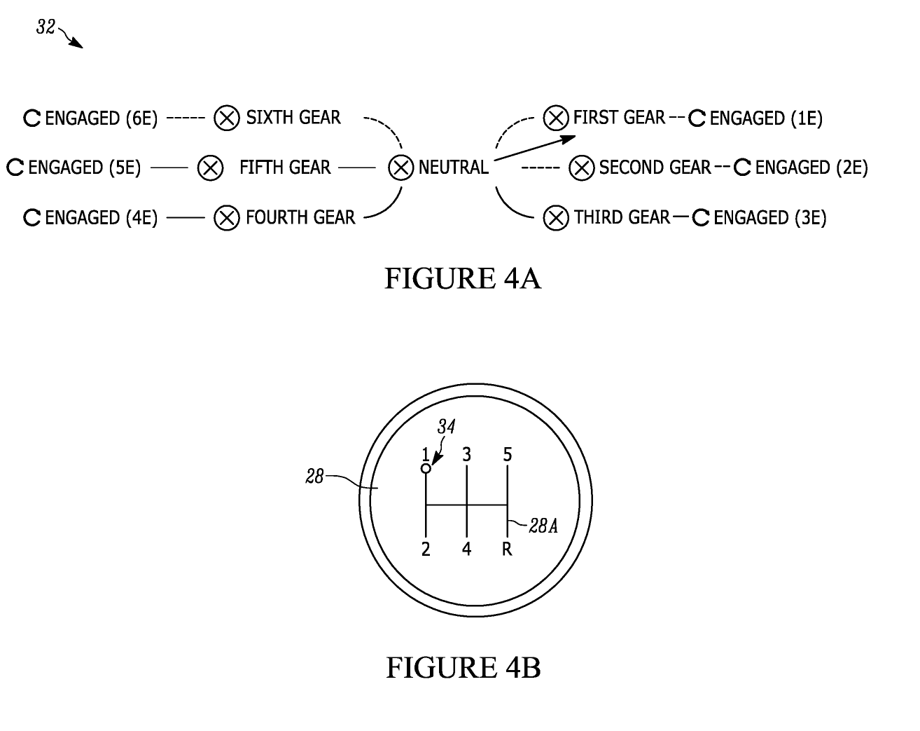

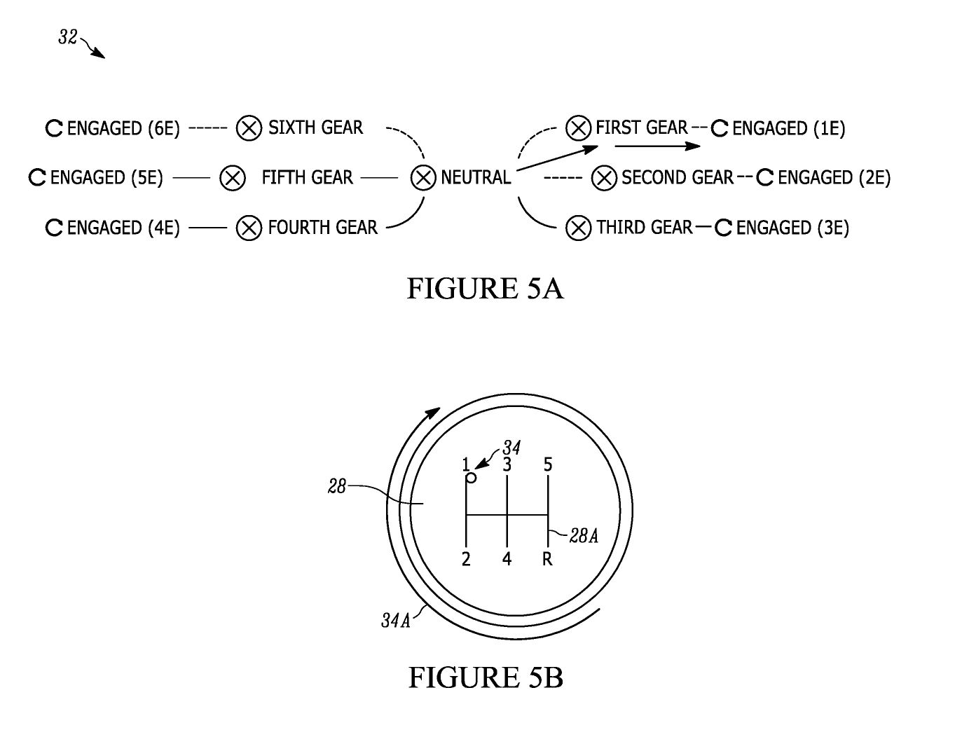

Referring now to FIGS. 2 and 4A-4B, when it is desired to change the transmission 16 from neutral to first gear, the shift lever 30 is moved to a first configuration as shown by arrow 28B, which follows the pattern shown in the shift pattern 28A, and the icon 34 provides an indication that the transmission 16 is configured for operating in first gear. However, although the transmission 16 is configured for operating in first gear, no power is transmitted from the engine 12 to the transmission 16 because the clutch mechanism 18 is in the disengaged configuration. Referring now to FIGS. 5A-5B, the clutch mechanism 18 is changed to an engaged configuration when the driver actuates the engager 26 by rotating the shift knob 28 approximately twenty degrees in a first direction, or clockwise direction, as shown by the arrow 34A. The rotation of the shift knob 28 sends a signal to the TCU 22 that the driver wants to change the clutch mechanism 18 to the engaged configuration, upon which the TCU 22 sends a signal to the ECA 20 to change the clutch mechanism 18 to the engaged position, and the engine 12 then transfers power to the transmission, propelling the vehicle forward. The acceleration of the vehicle is dependent upon the position of the accelerator pedal, the position of which is dependent upon the driver of the vehicle.

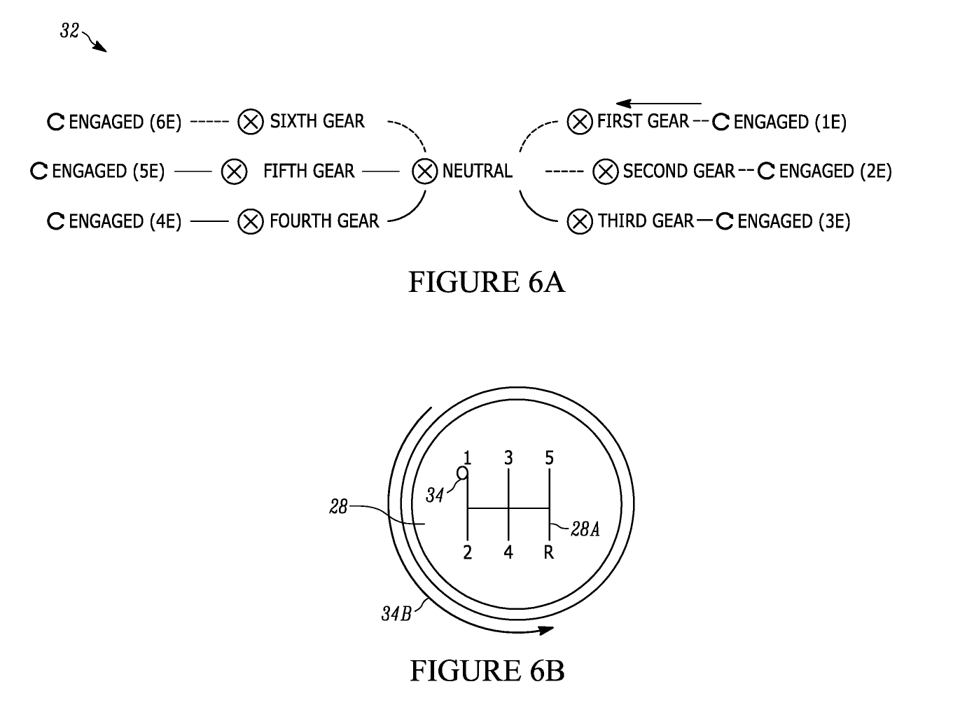

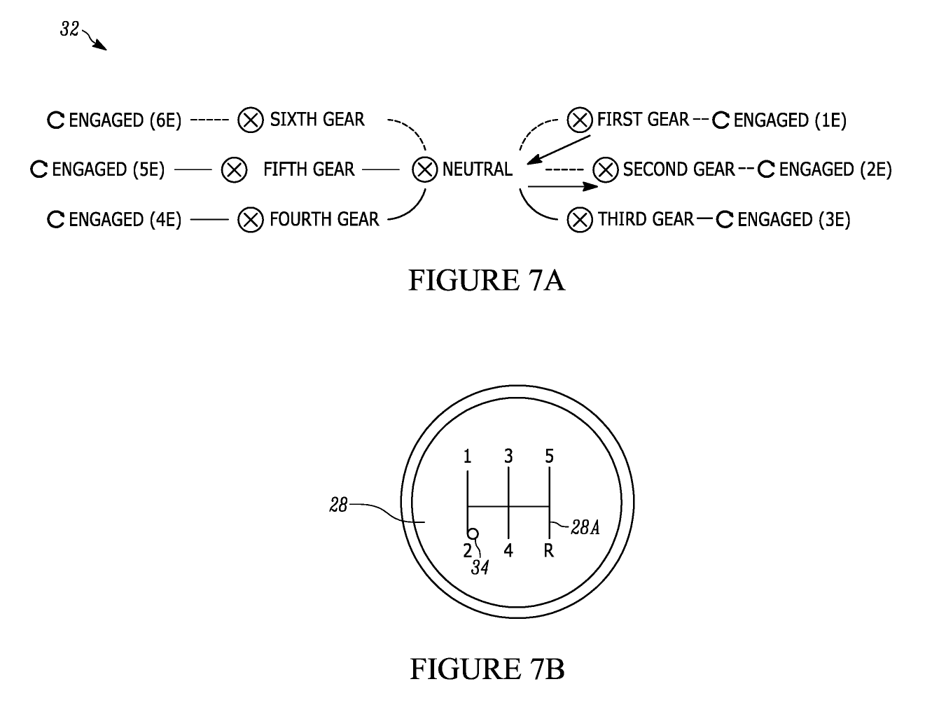

When it is desired to configure the transmission 16 for operating in second gear, the driver rotates the shift knob 28 approximately twenty degrees in a second direction, or counterclockwise direction, as shown by arrow 34B in FIGS. 6A-6B, which sends a signal to the TCU 22 that the driver wants to change the clutch mechanism 18 to the disengaged configuration, upon which the TCU 22 sends a signal to the ECA 20 to change the clutch mechanism 18 to the disengaged configuration, and the engine 12 then no longer transfers power to the transmission 16. The shift lever 30 is then reconfigured, as shown in FIGS. 7A-7B and by the arrow 28C in FIG. 2, where the shift lever 30 is moved through the neutral position, and the transmission 16 is configured to operate in second gear, which follows the pattern shown in the shift pattern 28A, and is shown by the icon 34.

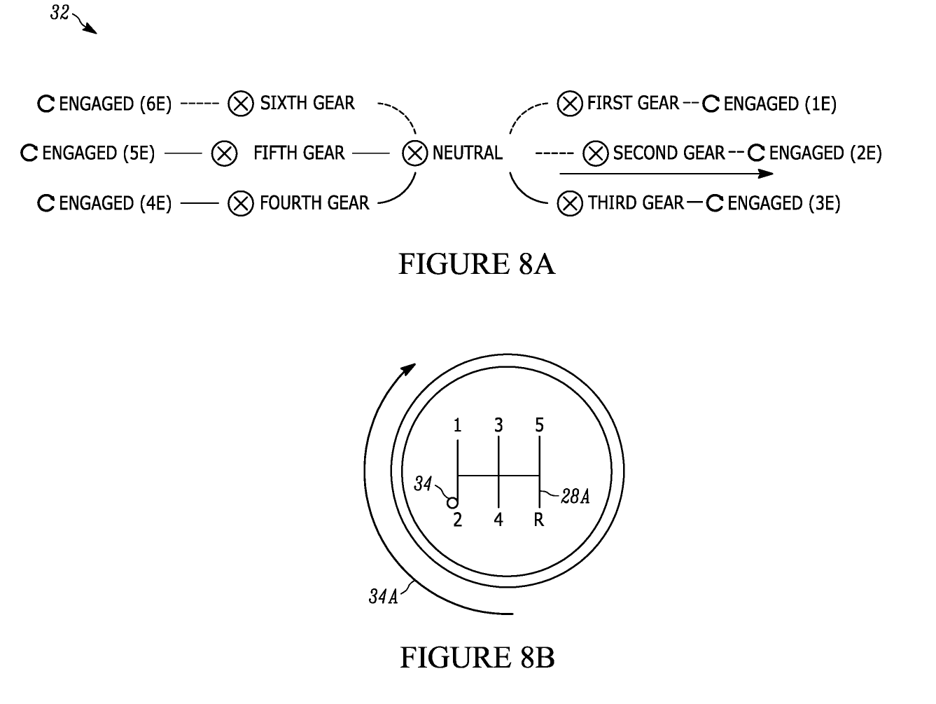

However, although the transmission 16 is configured for operating in second gear, again no power is transmitted from the engine 12 to the transmission 16 because the clutch mechanism 18 is in the disengaged configuration. Referring now to FIGS. 8A-8B, the clutch mechanism 18 is changed to an engaged configuration when the driver actuates the engager 26 by again rotating the shift knob 28 approximately twenty degrees in a clockwise direction as shown by arrow 34A, sending a signal to the TCU 22 that the driver wants to change the clutch mechanism 18 to the engaged configuration, upon which the TCU 22 sends a signal to the ECA 20 to change the clutch mechanism 18 to the engaged configuration, and the engine 12 then transfers power to the transmission, propelling the vehicle forward in second gear as the driver applies force to the accelerator pedal.

The process of rotating the shift knob 28 in a clockwise and counterclockwise direction, and moving the shift lever 30 to place the transmission 16 in the desired configuration is repeated for each gear until the vehicle is traveling at a desired speed.

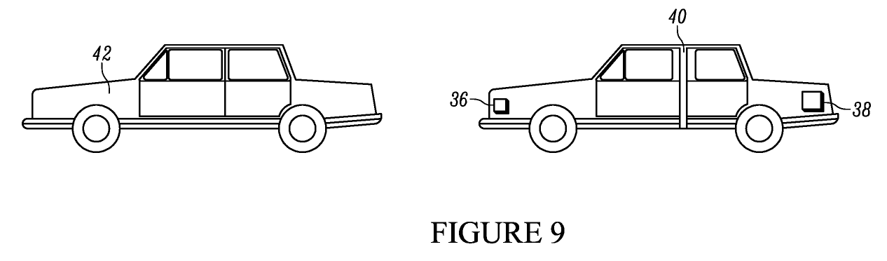

One of the features of the powertrain system 10 having the automated single clutch transmission with intelligent gear shift is referred to as a “follow-car” mode of operation, which is used along with several proximity sensors 36,38, to slowly move the vehicle in traffic. Referring to FIG. 9, an example of a vehicle 40 having the powertrain system 10 and proximity sensors 36,38 is shown. This mode of operation is used when there are heavy traffic volumes, and repeatedly rotating the shift knob 28 to engage and disengage the clutch mechanism 18 becomes cumbersome. Each of the proximity sensors 36,38 is in electrical communication with the TCU 22, and when the system 10 is placed in the follow-car mode of operation, the front proximity sensor 36 detects the presence of the followed vehicle 42 in front of the vehicle 40.

As the vehicle 42 moves forward at low speeds (i.e., under fifteen miles per hour) under heavy traffic conditions, the TCU 22 sends signals to the ECA 20 such that the ECA 20 selectively engages and disengages the clutch mechanism 18, selectively transferring power from the engine 12 to the transmission 16 to slowly move the vehicle 40 forward at the same rate of speed as the followed vehicle 42. The TCU 22 communicates with the ECU 14 and ECA 20 such that ECU 14 controls the operating speed of the engine 12 and the ECA 20 provides smooth engagement between the engine 12 and the transmission 16, moving the vehicle 40 forward at the same rate of speed as the followed vehicle 42. The ECU 14 is also in electrical communication with the brake pedal, and if the vehicle 42 decreases speed, and driver of the vehicle 40 applies the brake pedal to decrease the speed of the vehicle 40, a signal that the brake pedal has been applied is detected by the ECU 14 and TCU 22, such that the TCU 22 commands the ECA 20 to disengage the clutch mechanism 18, and the ECU 14 decreases the operating speed of the engine 12. If the followed vehicle 42 is travelling at a steady speed, and it is therefore desired to maintain a steady speed of the vehicle 40, the driver does not need to apply force to the brake pedal. The TCU 22 commands the ECA 20 to engage the clutch mechanism 18, and the ECU 14 changes the operating speed of the engine 12 such that the vehicle 40 travels at approximately the same speed as the followed vehicle 42.

Another feature of the powertrain system 10 having the automated single clutch transmission with intelligent gear shift is a “park-assist” mode of operation. In the park-assist mode of operation, the transmission 16 is configured to be in a reverse mode of operation, and when the driver of the vehicle 40 actuates the engager 26 by rotating the shift knob 28 approximately twenty degrees in the clockwise direction, the clutch mechanism 18 is changed to an engaged configuration, and the driver of the vehicle 40 applies force to the accelerator pedal such that the vehicle 40 begins moving in reverse. However, rear proximity sensor 38 is able to detect any objects behind the vehicle 40, and the rear proximity sensor 38 is in electrical communication with the TCU 22. If the rear proximity sensor 38 detects an object (i.e., another vehicle, a wall, a pedestrian, etc.) behind the vehicle 40, the rear proximity sensor 38 sends a signal to the TCU 22, and the TCU 22 commands the ECA 20 to disengage the clutch mechanism 18, and the ECU 14 decreases the operating speed of the engine 12. During this mode of operation, the speed of the vehicle 40 may be decreased either by the driver of the vehicle 40 applying force to the brake pedal, or the ECU 14 may be in electrical communication with the brake system such that the ECU 14 may command the brake system to decrease the speed of the vehicle as the ECU 14 decreases the operating speed of the engine 12 and the TCU 22 commands the ECA 20 to disengage the clutch mechanism 18. The park-assist mode of operation also includes an “automatic engager” option, where the driver of the vehicle 40 does not need to actuate the engager 26 to engage/disengage the clutch mechanism 18, but rather the TCU 22 controls the ECA 20 and clutch mechanism 18 when the driver of the vehicle 40 configures the vehicle 40 for operating in the reverse mode of operation.

In an alternate embodiment, the powertrain system 10 optionally includes an electronic clutch pedal (ECP) 44 to function as the engager 26 (shown in FIG. 1), which functions as an electronic switch, where upon application of force to the ECP 44, a signal is sent to the TCU 22 that the ECP 44 has been actuated, and the TCU 22 commands the ECA 20 to disengage the clutch mechanism 18. When force is no longer applied to the ECP 44, a signal is sent to the TCU 22 that the ECP 44 has been released, and the TCU 22 commands the ECA 20 to re-engage the clutch mechanism 18. In this embodiment, the ECP 44 may be used with the system 10, such that the driver uses the ECP 44 to engage and disengage the clutch mechanism 18, instead of rotating the shift knob 28. In this embodiment, the ECP 44 may be used to engage and disengage the clutch mechanism 18, instead of rotating the shift knob 28, depending upon the desire of the driver. The option to change how the clutch mechanism 18 is actuated may be changed through the use of a switch in the instrument cluster, or some other type of interface between the vehicle 40 and the driver.

The engager 26 described above is a rotatable shift knob 28. However, it is within the scope of the invention that the engager 26 may be any device, sensor or group of sensors, or suitable actuation by the driver of the vehicle to control actuation of the ECA 20 through the TCU 22.

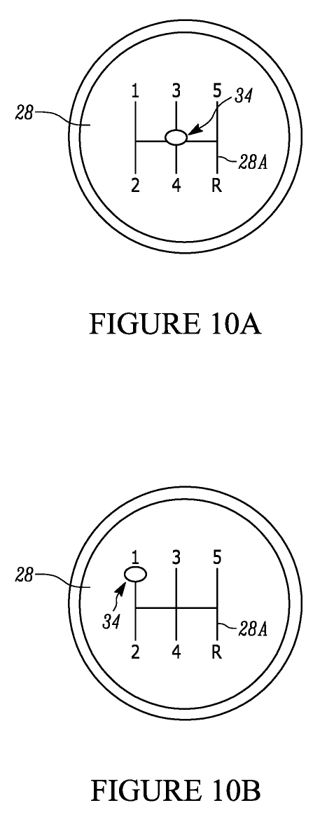

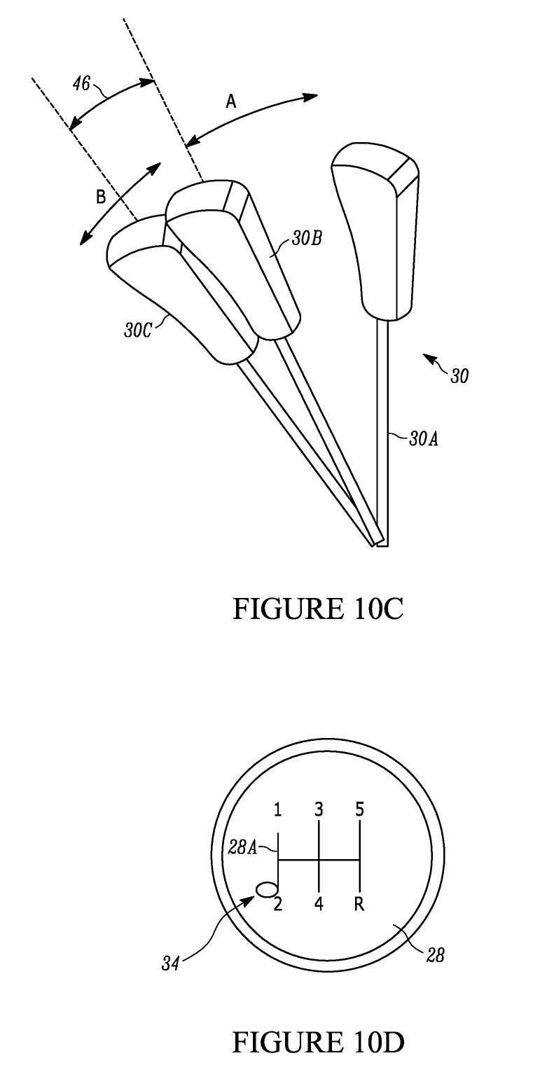

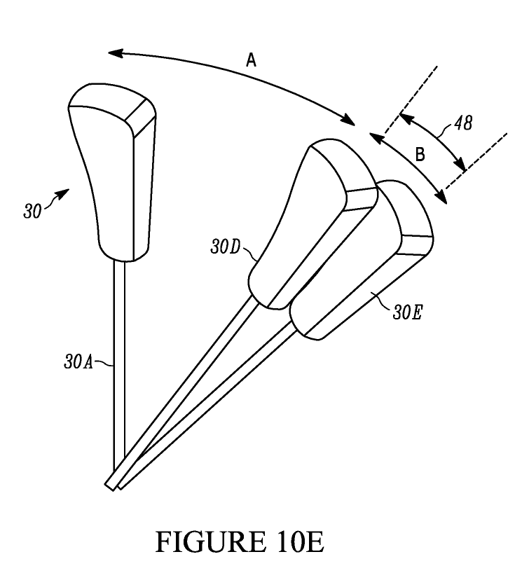

For example, instead of rotating the shift knob 28, the engager 26 may be an additional movement of the shift lever 30. In an alternate embodiment, the shift lever 30, is moved to different configurations, shown in FIGS. 10A-10E. In this embodiment, the shift pattern 28A is still the same for configuring the operation of the transmission 16, but in this embodiment the shift lever 30 has a secondary movement after configuring the transmission 16 to operate in a particular gear, where the shift lever 30 is moved to send a signal to the TCU 22, such that TCU 22 commands the ECA 20 to engage or disengage the clutch mechanism 18. Initially, the shift lever 30 is in the first position, or neutral position, as indicated at 30A in FIGS. 10A and 10C, and indicated by the icon 34. To configure the transmission 16 for operating in first gear, the shift lever 30 is moved in the direction as shown by the arrow 28B in FIG. 2, and indicated at 30B and by the icon 34 in FIGS. 10B and 10C. However, the engine 12 is still not transferring torque to the transmission 16 because the clutch mechanism 18 is in the disengaged configuration. In this embodiment, there is additional movement of the shift lever 30, which acts as the engager 26. More specifically, the shift lever 30 is moved along the angle 46 as shown in FIG. 10C, from the configuration as indicated at 30B to the configuration as indicated at 30C, in which case a signal is sent to the TCU 22 that the driver desires to change the clutch mechanism 18 to the engaged configuration, upon which the TCU 22 sends a signal to the ECA 20 to change the clutch mechanism 18 to the engaged position, and the engine 12 then transfers power to the transmission, propelling the vehicle forward.

Again, the acceleration of the vehicle is dependent upon the position of the accelerator pedal, the position of which is dependent upon the driver of the vehicle. It should be noted that the change from the configuration as indicated at 30B to the configuration as indicated at 30C is a straight-line movement, as opposed to the movement the shift lever 30 undergoes from the position indicated at 30A to the position indicated at 30B and shown in FIGS. 10A-10C, and indicated by arrow 28B in FIG. 2.

When it is desired to configure the transmission 16 to operate in second gear, the shift lever 30 is again moved about angle 46 from the configuration as indicated at 30C to the configuration as indicated at 30B, which sends a signal to the TCU 22 that the driver desires to change the clutch mechanism 18 to the disengaged configuration, upon which the TCU 22 sends a signal to the ECA 20 to change the clutch mechanism 18 to the disengaged configuration. The shift lever 30 is then moved through the neutral position as shown in FIGS. 10D-10E such that the shift lever 30 is in the configuration indicated at 30D, which also follows the pattern shown in the shift pattern 28A and indicated by the arrow 28C in FIG. 2, such that the transmission 16 is configured for operating in second gear, as indicated by the icon 34 in FIG. 10D. The shift lever 30 then is moved along the angle 48 as shown in FIG. 10E, from the configuration as indicated at 30D to the configuration as indicated at 30E, in which case a signal is sent to the TCU 22 that the driver desires to change the clutch mechanism 18 to the engaged configuration, upon which the TCU 22 sends a signal to the ECA 20 to change the clutch mechanism 18 to the engaged configuration, and the engine 12 then transfers power to the transmission 16. To disengage the clutch mechanism 18, the shift lever 30 is again moved about angle 48 from the configuration as indicated at 30E to the configuration as indicated at 30D, which sends a signal to the TCU 22 that the driver desires to change the clutch mechanism 18 to the disengaged configuration, upon which the TCU 22 sends a signal to the ECA 20 to change the clutch mechanism 18 to the disengaged position. The shift lever 30 may then be moved back to the neutral configuration, as shown in FIG. 10A, or to one of the other gear configurations.

The same process is used for configuring the transmission 16 to operate in third gear, fourth gear, fifth gear, and reverse, where the shift lever 30 is moved using the secondary movement to engage and disengage the clutch mechanism 18.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
a transmission for a vehicle, including:
an intelligent gear shift lever;
an engager;
a clutch mechanism; and
at least one control unit in electrical communication with the intelligent gear shift lever, the engager, and the clutch mechanism such that the at least one control unit is able to receive signals from the intelligent gear shift lever and the engager, and the at least one control unit controls the actuation of the clutch mechanism based on the signals received from the intelligent gear shift lever and the engager; and
wherein the intelligent gear shift lever is used to configure the automated single clutch transmission for operating in one of a plurality of gear configurations, and the engager is used to command the at least one control unit to change the clutch mechanism between an engaged configuration and a disengaged configuration.

2. The apparatus of claim 1, the engager further comprising a rotatable shift knob connected to the intelligent gear shift lever.

3. The apparatus of claim 2, wherein the shift knob is rotated in a first direction to send a signal to the at least one control unit such that the at least one control unit places the clutch mechanism in the engaged configuration, and the shift knob is rotated in a second direction to send a signal to the at least one control unit such that the at least one control unit places the clutch mechanism in a disengaged configuration.

4. The apparatus of claim 1, the engager further comprising a secondary movement of the intelligent gear shift lever, wherein after the intelligent gear shift lever is used to configure the transmission for operating in one of the plurality of gear configurations, the secondary movement of the intelligent gear shift lever along an angle in a first direction sends a signal to the at least one control unit to place the clutch mechanism in the engaged configuration, and the secondary movement of the intelligent gear shift lever along the angle in a second direction sends a signal to the at least one control unit to place the clutch mechanism in the disengaged configuration.

5. The apparatus of claim 1, the engager further comprising one or more sensors operable for detecting when it is desired to change the transmission for operating in one of the plurality of gear configurations.

6. The apparatus of claim 1, further comprising a park-assist mode of operation.

7. The apparatus of claim 6, the park-assist mode of operation further comprising:
a rear proximity sensor in electrical communication with the at least one control unit;
wherein after the intelligent gear shift lever is used to configure the transmission to a reverse mode of operation and the engager is used to change the clutch mechanism to the engaged configuration, and as the vehicle is moving backward the at least one controller changes the clutch mechanism to the disengaged configuration when the rear proximity sensor detects an object behind the vehicle.

8. The apparatus of claim 7, the vehicle further comprising a brake system, wherein the at least one controller is in electrical communication with the brake system such that the at least one controller commands the brake system to decrease the speed of the vehicle as the at least one controller disengages the clutch mechanism.

9. The apparatus of claim 1, further comprising follow-car mode of operation.

10. The apparatus of claim 9, the follow-car mode of operation further comprising:
a front proximity sensor in electrical communication with the at least one control unit, the front proximity sensor operable for detecting a followed vehicle;
wherein the at least one control unit changes the clutch mechanism between the engaged configuration and the disengaged configuration to selectively transfer power to the transmission such that the vehicle moves at the same pace as the followed vehicle.

11. The apparatus of claim 10, the vehicle further comprising a brake system, wherein the at least one controller is in electrical communication with the brake system such that if the followed vehicle decreases speed, the at least one controller commands the brake system to decrease the speed of the vehicle and the at least one controller disengages the clutch mechanism.

12. The apparatus of claim 1, the engager further comprising an electronic clutch pedal, wherein upon application of force to the electronic clutch pedal, a signal is sent to the at least one control unit that the electronic clutch pedal has been actuated, and the at least one control unit changes the clutch mechanism to the disengaged configuration, and when force is no longer applied to the electronic clutch pedal, a signal is sent to the at least one control unit that the electronic clutch pedal has been released, and the at least one control unit changes the clutch mechanism to the engaged configuration.

13. The apparatus of claim 1, further comprising:
an electronic clutch actuator in electrical communication with the at least one control unit for controlling the clutch mechanism;
wherein at least one control unit is able to receive signals from the intelligent gear shift lever and the engager, and the at least one control unit is able to send signals to the electronic clutch actuator based on the signals received from the intelligent gear shift lever and the engager to change the clutch mechanism between the engaged configuration and the disengaged configuration.

14. An automated single-clutch transmission, comprising:
a gear shift lever;
at least one control unit in electrical communication with the gear shift lever;
an electronic clutch actuator in electrical communication with the at least one control unit;
a clutch mechanism operable for being placed in an engaged configuration and a disengaged configuration, the configuration of the clutch mechanism being controlled by the electronic clutch actuator; and
an engager in electrical communication with the at least one control unit such that the engager sends a signal to the at least one control unit to command the electronic clutch actuator to change the clutch mechanism between the engaged configuration and the disengaged configuration;
wherein the engager is used to change the clutch mechanism to the engaged configuration after the gear shift lever places the transmission into one of a plurality of gear configurations, and the engager is used to change the clutch mechanism to the disengaged configuration prior to the gear shift lever being used to change the transmission to another of the plurality of gear configurations.

15. The automated single-clutch transmission of claim 14, the gear shift lever further comprising an intelligent gear shift lever.

16. The automated single-clutch transmission of claim 14, the engager further comprising:
a rotatable shift knob mounted to the gear shift lever;
wherein the shift knob is rotated in a first direction to send a signal to the electronic clutch actuator to place the clutch mechanism in the engaged configuration, and the shift knob is rotated in a second direction to send a signal to the electronic clutch actuator to place the clutch mechanism in the disengaged configuration.

17. The automated single-clutch transmission of claim 14, the engager further comprising a secondary movement of the intelligent shift lever, wherein after the intelligent gear shift lever is used to configure the transmission for operating in one of the plurality of gear configurations, the secondary movement of the intelligent gear shift lever along an angle in a first direction sends a signal to the electronic clutch actuator to place the clutch mechanism in the engaged configuration, and the secondary movement of the intelligent gear shift lever along the angle in a second direction sends a signal to the electronic clutch actuator to place the clutch mechanism in the disengaged configuration

18. The automated single-clutch transmission of claim 14, further comprising:
a rear proximity sensor in electrical communication with the at least one control unit;
wherein the at least one controller configures the transmission for operating in a park-assist mode of operation, such that after the intelligent gear shift lever is used to configure the transmission to operate in a reverse mode of operation and the engager is used to change the clutch mechanism to the engaged configuration, and as the vehicle is moving backwards the at least one controller commands the electronic clutch actuator to change the clutch mechanism to the disengaged configuration when the rear proximity sensor detects an object behind the vehicle.

19. The automated single-clutch transmission of claim 18, the vehicle further comprising a brake system, wherein the at least one controller is in electrical communication with the brake system such that the at least one controller commands the brake system to decrease the speed of the vehicle as the at least one controller disengages the clutch mechanism.

20. The automated single-clutch transmission of claim 14, further comprising:
a front proximity sensor in electrical communication with the at least one control unit, the front proximity sensor operable for detecting a followed vehicle;
wherein the at least one controller configures the transmission for operating in a follow-car mode of operation, where the at least one control unit commands the electronic clutch actuator to change the clutch mechanism between the engaged configuration and the disengaged configuration such that power is selectively transferred to the transmission, and the vehicle moves at the same pace as the followed vehicle.

21. The automated single-clutch transmission of claim 20, the vehicle further comprising a brake system, wherein the at least one controller is in electrical communication with the brake system such that if the followed vehicle decreases speed, the at least one controller commands the brake system to decrease the speed of the vehicle and the at least one controller disengages the clutch mechanism.

22. The automated single-clutch transmission of claim 14, the engager further comprising an electronic clutch pedal, wherein upon application of force to the electronic clutch pedal, a signal is sent to the at least one control unit that the electronic clutch pedal has been actuated, and the at least one control unit commands the electronic clutch actuator to change the clutch mechanism to the disengaged configuration, and when force is no longer applied to the electronic clutch pedal, a signal is sent to the at least one control unit that the electronic clutch pedal has been released, and the at least one control unit commands the electronic clutch actuator to change the clutch mechanism to the engaged configuration.

23. The automated single-clutch transmission of claim 14, the engager further comprising one or more sensors operable for detecting when it is desired to change the transmission for operating in one of the plurality of gear configurations.
